(19) United States
(12) Patent Application Publication
(10) Pub. No.: US 2005/0149912 A1
(43) Pub. Date: Jul. 7, 2005

(54) Dynamic online optimizer

(75) Inventors: Alexandre J. Farcy, Hillsboro, OR (US); Stephan J. Jourdan, Portland, OR (US); Avinash Sodani, Hillsboro, OR (US); Per H. Hammarlund, Hillsboro, OR (US)

Correspondence Address: KENYON & KENYON, Suite 600, 333 W. San Carlos Street, San Jose, CA, 95110-2711, US

(73) Assignee: Intel Corporation

(21) Appl. No.: 10/748,284

(22) Filed: Dec. 29, 2003

(51) Int. Cl. G06F 9/44

(52) U.S. Cl. 717/124

(57) ABSTRACT

A system and method for optimizing a series of traces to be executed by a processing core is disclosed. The lines of a trace are sent to an optimizer each time they are sent to a processing core to be executed. Runtime information may be collected on a line of a trace each time that trace is executed by a processing core. The runtime information may be used by the optimizer to better optimize the micro-operations of the lines of the trace. The optimizer optimizes a trace each time the trace is executed to improve the efficiency of future iterations of the trace. Most of the optimizations result in a reduction of the number of μops within the trace. The optimizer may optimize two or more lines at a time in order to find more opportunities to remove μops and shorten the trace. The two lines may be alternately offset so that each line has the maximum allowed number of micro-operations.

### BACKGROUND OF THE INVENTION

The present invention pertains to a method and apparatus for optimizing traces. More particularly, the present invention pertains to optimizing a trace each time that the trace is executed.

A trace is a series of micro-operations, or μops, that may be executed by a processor. Each trace may contain one or more lines, with each line containing up to a set number of μops. Each of these μops describes a different task or function to be executed by a processing core of a processor.

A processor is a device that executes a series of micro-operations, or fops. Each of these μops describes a different task or function to be executed by a processing core of a processor. The μops are a translation of the instructions generated by a compiler. An instruction cache stores the static code received from the compiler via the memory. The instruction cache passes this set of instructions to a virtual machine, such as a macro-instruction translation engine (MITE), which decodes the instructions to build a set of μops.

A processor may have an instruction fetch mechanism and an instruction execution mechanism. An instruction buffer separates the fetch and execution mechanisms. The instruction fetch mechanism acts as a “producer” which fetches, decodes, and places instructions into the buffer. The instruction execution engine is the “consumer” which removes instructions from the buffer and executes them, subject to data dependence and resource constraints. Control dependencies provide a feedback mechanism between the producer and consumer. These control dependencies may include branches or jumps. A branching instruction is an instruction that may have one following instruction under one set of circumstances and a different following instruction under a different set of circumstances. A jump instruction may skip over the instructions that follow it under a specified set of circumstances.

Because of branches and jumps, instructions to be fetched during any given cycle may not be in contiguous cache locations. The instructions are placed in the cache in their compiled order. Hence, there must be adequate paths and logic available to fetch and align noncontiguous basic blocks and pass them up the pipeline. Storing programs in static form favors fetching code that does not branch or code with large basic blocks. Neither of these cases is typical of integer code. That is, it is not enough for the instructions to be present in the cache, it must also be possible to access them in parallel.

To remedy this, a special instruction cache is used that captures dynamic instruction sequences. This structure is called a trace cache because each line stores a snapshot, or trace, of the dynamic instruction stream. A trace is a sequence of μops, broken into a set of lines, starting at any point in the dynamic instruction stream. A trace is fully specified by a starting address and a sequence of branch outcomes describing the path followed. The first time a trace is encountered, it is allocated entries in the trace cache to hold all the lines of the trace. The lines are filled as instructions are fetched from the instruction cache. If the same trace is encountered again in the course of executing the program, i.e. the same starting address and predicted branch outcomes, it will be available in the trace cache and its lines will be sent to the trace queue. From the trace queue the sops will be read and sent to allocation. The processor executes these μops unoptimized. Otherwise, fetching proceeds normally from the instruction cache.

When the trace lines have been read from the trace cache and stored in the trace queue, they are sent from the trace queue to the optimizer and stored optimized in the trace cache, overwriting the previously unoptimized version of the trace. The lines of the optimized trace replace those of the unoptimized trace. When the processor reads this trace from the trace cache, it will execute optimized code. These optimizations allow the μops to be executed more efficiently by the processor. The optimizations may alter a μop, combine μops into a single μop, or eliminate an unnecessary μop altogether.

### BRIEF DESCRIPTION OF THE DRAWINGS

FIG. 1 is a block diagram of an embodiment of a portion of a processor employing an optimizer according to the present invention.

FIG. 2 is a flowchart showing an embodiment of a method for optimizing a trace according to the present invention.

FIG. 3 is a flowchart showing an embodiment of a method for packing the lines of a trace according to the present invention.

FIG. 4 is a block diagram of an embodiment of a portion of a processor employing an optimizer using runtime information according to the present invention.

FIG. 5 shows a computer system that may incorporate embodiments of the present invention.

### DETAILED DESCRIPTION

A system and method for optimizing a series of traces to be executed by a processing core is disclosed. In one embodiment, the lines of a trace are sent to an optimizer each time they are sent to a processing core to be executed. Runtime information may be collected on a trace each time that trace is executed by a processing core. The runtime information may be used by the optimizer to better optimize the micro-operations of the lines of the trace. The optimizer optimizes a trace each time the trace is executed to improve the efficiency of future iterations of the trace. Most of the optimizations result in a reduction of the number of μops within the trace. The optimizer may optimize two or more lines at a time in order to find more opportunities to remove pops and shorten the trace. The two lines may be alternately offset so that each line has the maximum allowed number of micro-operations.

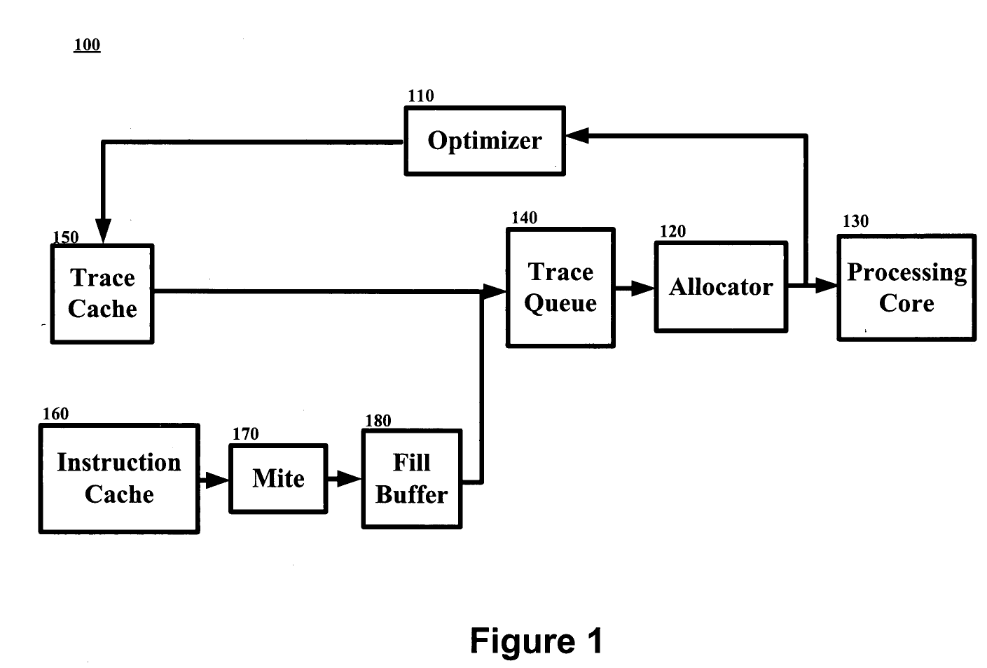

FIG. 1 illustrates in a block diagram a portion of a processor 100 using an optimizer 110 according to the present invention. An allocator 120 may send a trace to the optimizer 110 each time the trace is sent to the processing core 130 to be executed. The optimizer 110 may be a pipelined optimizer that has the same throughput as the allocator 120. The processing core 130 may be an out of order processing core. The allocator 120 may retrieve the trace from a trace queue 140. The traces may be organized in the trace queue 140 in the order that they are to be processed by the processing core 130. The allocator 120 may send part of a line or a full line of a trace to the optimizer 110 and the processing core 130 at a time. After the optimizer 110 has optimized the one or more lines of the trace, the optimized trace lines may be stored in a trace cache 150. If the trace is to be processed again by the processing core 130, the trace may be sent from the trace cache 150 to a trace queue 140, which feeds traces to the allocator. An instruction cache 160 stores the static code received from the compiler via the memory (compiler and memory not shown in FIG. 1). The instruction cache 160 may pass the instructions to a macro-instruction translation engine (MITE) 170, which translates the instructions to a set of micro-operations (μops). The μops may then be passed to a fill buffer 180. When a complete line of μops is stored within the fill buffer 180 forming a trace line, the trace line may then be sent to the trace queue 140.

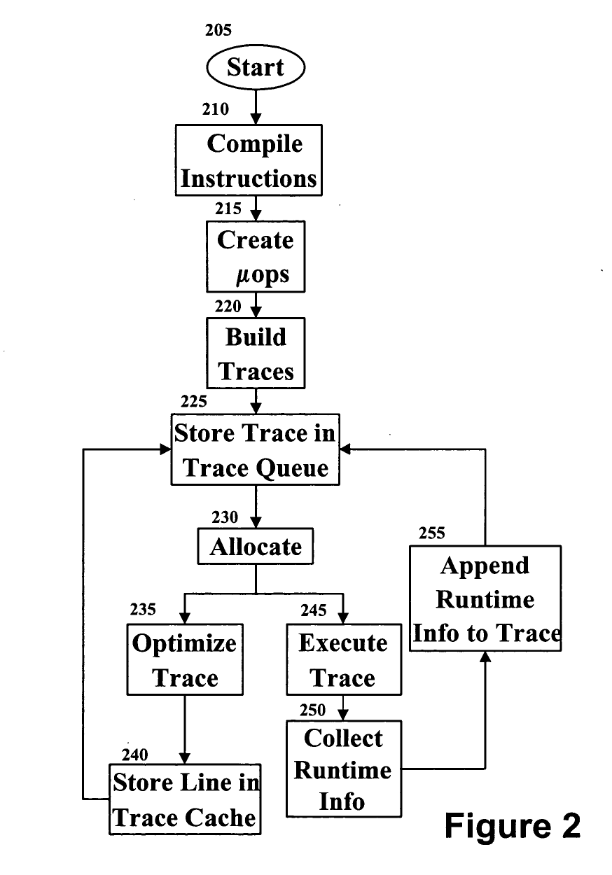

FIG. 2 illustrates in a flowchart one embodiment of a method for optimizing according to the present invention. The process starts (Block 205) by compiling a set of instructions and storing the instructions in the instruction cache 160 (Block 210). The mite creates a set of μops from the set of instructions (Block 215). The sops are stored in the fill buffer 180 until a trace line is built (Block 220). The traces are then stored in the trace queue 140 (Block 225). The lines of the traces are then sent to the optimizer each time they are sent to the processing core 130 by the allocator 120 (Block 230). The optimizer 110 optimizes the traces by executing any number of optimizations on one or more consecutive lines of μops (Block 235). The optimized lines of μops may then be stored in the trace cache 150 (Block 240). When the trace is to be executed by the processing core 130 again, the trace is stored in the trace queue 140 (Block 225). Simultaneous with the optimization, the traces are executed by the processing core 130 (Block 245).

The optimizer may be a circuitry device executing firmware. The optimizer may execute a number of optimizations, such as call return elimination, dead code elimination, dynamic pop fusion, binding, load balancing, move elimination, common sub-expression elimination, constant propagation, redundant load elimination, store forwarding, memory renaming, trace specialization, value specialization, reassociation, and branch promotion.

Call-return elimination removes call and return instructions surrounding a subroutine code. Dead code elimination removes pops that generate data that is not actually consumed by any other pop. Dynamic μop fusion combines two or more pops into one μop. Binding binds a μop to a resource. Load balancing binds μops to resources so that resources are efficiently used. Move elimination flattens the dependence graph by replacing references to the destination of a move pop by references to the source of the move μop.

Common sub-expression elimination removes the code that generates data that was already computed. Constant propagation replaces references to a register by references to a constant when the register value is known to be a constant within the trace. Redundant load elimination removes a load pop if it accesses an address that was already read within the trace. Store forwarding and memory renaming replace memory accesses of load μops by register accesses. Value specialization replaces variables that have a constant value for a particular trace with that value.

Trace specialization creates a trace assuming a specific value for an input or a set of inputs of a given trace. The specialized trace cannot be executed if the value happens to be different from the value assumed by the optimizer. Reassociation works on pairs of dependent immediate instructions and modifies the second instruction by combining the numerical sources of the pair. Reassociation also changes the source of that second instruction to be the source of the first instruction, rather than the destination of the first instruction. Branch promotion converts strongly biased branches into branches with static conditions. Other optimizations may be used as well.

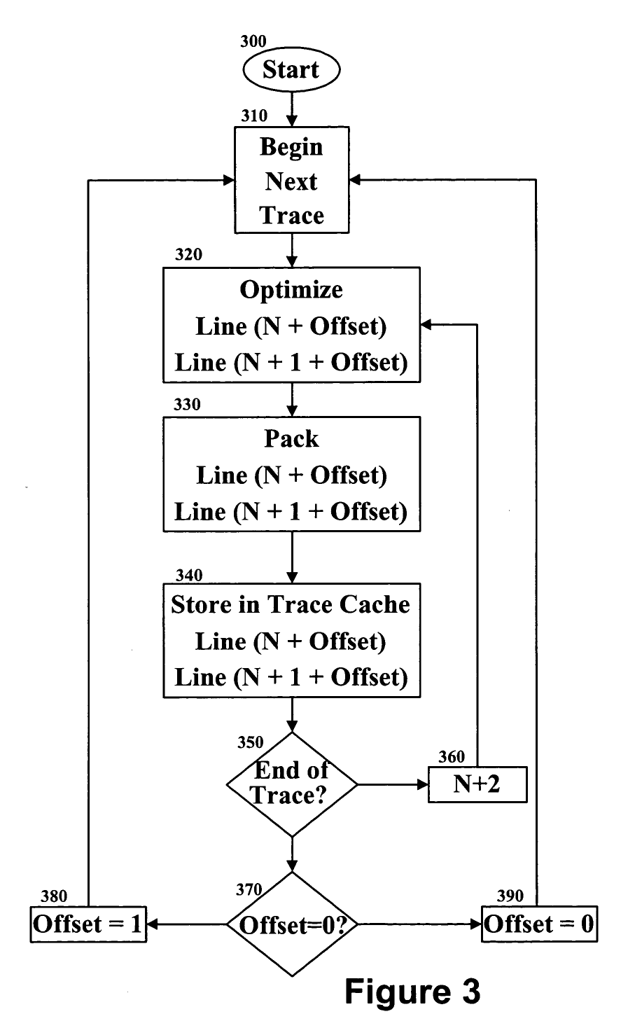

The optimizer 110 may also pack the lines as it optimizes the μops of the lines, as the optimizations may result in a reduction in the number of μops. FIG. 3 illustrates in a flowchart one embodiment of a method for packing the lines within the optimizer 130. The process begins (Block 300) and a first trace is sent through the optimizer 130 (Block 310). Two consecutive lines of the trace are taken together (such as the first with the second, the third with the fourth, and so on) and optimized (Block 320). If the number of μops in the first line is reduced, the first line is packed after optimization has been completed (Block 330). Packing may be executed by moving μops from the second line into the first line until the first line is full. For example, if each line has a maximum of ten Hops and the number of μops in the first line is seven after optimization, the first three μops of the second line may be appended to the end of the first line.

The number of μops in the second line at this point may then also have been reduced by the optimizations. The first line and the second line may then be stored in the trace cache (Block 340). If, after packing, all μops from the second line have been moved to the first line, then the second line is removed from the trace and only the first line is stored in the trace cache. The number of μops in the second line at this point may then have been reduced by optimization and packing. If the end of the trace has not been reached (Block 350), then the next two lines of the trace are taken by the optimizer (Block 360) and optimized (Block 320). If the end of the trace has been reached (Block 350) and the line number was not offset this run through (Block 370), then the next time that trace is optimized the line number may be offset by one (Block 380) so that different lines (such as the second with the third, the fourth with the fifth, and so on) are optimized together (Block 320). Then the packing is executed (Block 330) to move pops from the third line to the second line. If the line number was offset this run through (Block 370), then the next time that trace is optimized the line number may not be offset (Block 390) so that the first line and second line are optimized together (Block 320).

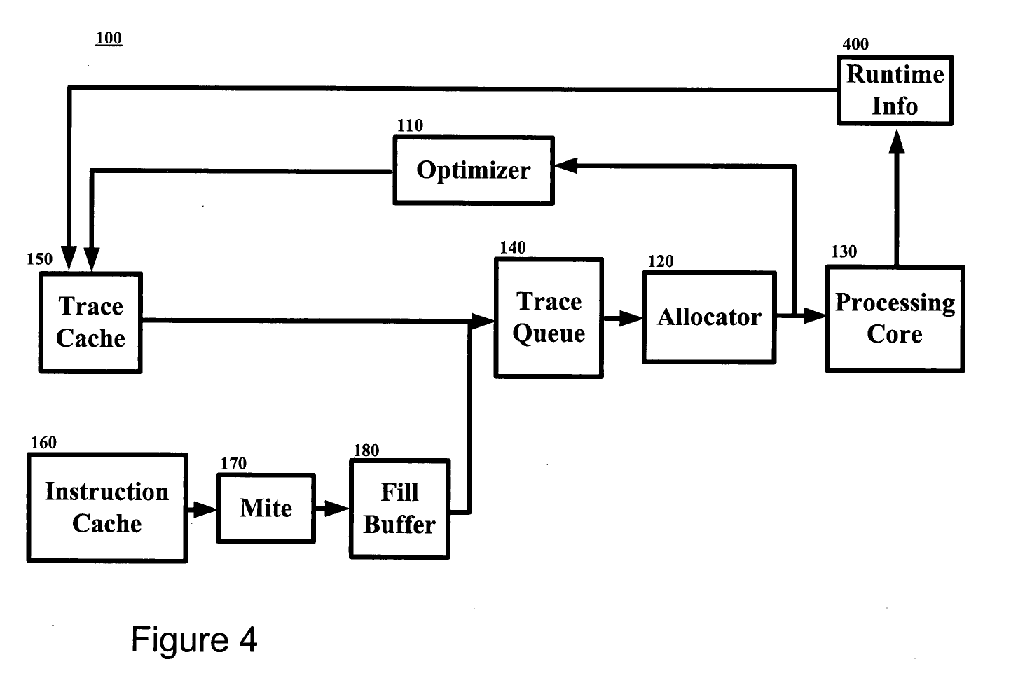

In one embodiment, feedback from the processing core may be used to improve the optimizations. FIG. 4 illustrates in a block diagram one embodiment of a portion of a processor in which runtime information is collected by the processing core 130. Runtime information 400 may be collected on the trace each time the trace is retired by the processing core 130 after execution. This runtime information 400 is sent to the trace cache 150, where it may be appended to the line. Alternatively, the runtime information 400 may be stored in a separate buffer that is mapped to the trace cache so that each set of runtime information is connected to the relevant trace. The next time that trace is executed and optimized, the optimizer 110 may use that runtime information 400 to better determine which optimizations to execute on the trace. For example, load balancing and specialization are optimizations that can be driven by this runtime information. One embodiment of this process is shown in the flowchart of FIG. 2. After the trace is executed by the processing core 130 (Block 245), the runtime information may be collected (Block 250) and appended to the trace in the trace cache 250 (Block 255). The runtime information may then be sent to the trace queue 140 with its trace when that trace is to be executed and optimized again.

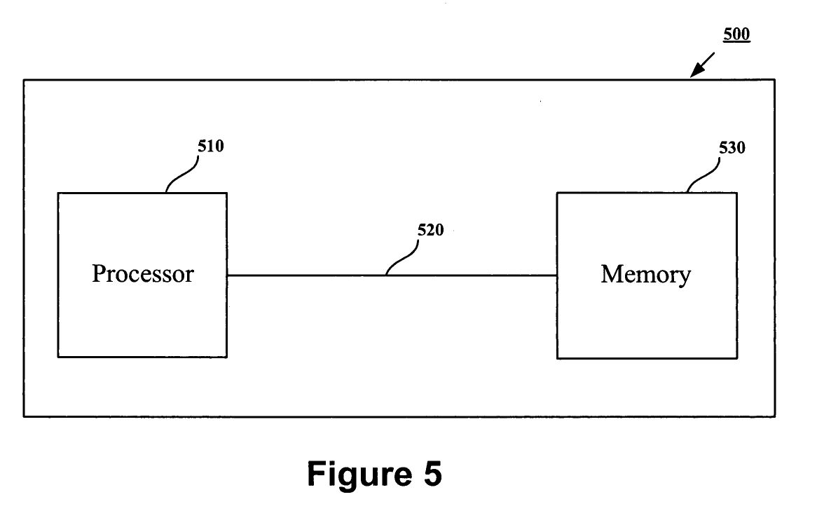

FIG. 5 shows a computer system 500 that may incorporate embodiments of the present invention. The system 500 may include, among other components, a processor 510, a memory 530 (e.g., such as a Random Access Memory (RAM)), and a bus 520 coupling the processor 510 to memory 530. In this embodiment, processor 510 operates similarly to the processor 100 of FIG. 1 and executes instructions provided by memory 530 via bus 520.

Although a single embodiment is specifically illustrated and described herein, it will be appreciated that modifications and variations of the present invention are covered by the above teachings and within the purview of the appended claims without departing from the spirit and intended scope of the invention.

1. A processor comprising:
a processing core to execute a trace having one or more lines of one or more micro-operations; and
an optimizer to optimize the trace upon each execution of the trace by the processing core.

2. The processor of claim 1, wherein the optimizer is a pipelined optimizer.

3. The processor of claim 1, further comprising a trace cache to store a trace from said optimizer.

4. The processor of claim 3, further comprising:
an instruction cache to store static code received from a compiler via a memory;
a mite to translate the static code into micro-operations; and
a fill buffer to build a trace from the micro-operations.

5. The processor of claim 4, further comprising a trace queue to store one or more lines of one or more traces from the fill buffer and one or more lines from one or more traces from the trace cache.

6. The processor of claim 5, further comprising an allocator to send traces from the trace queue to the processing core and the optimizer.

7. The processor of claim 1, wherein the processing core is an out of order processing core.

8. The processor of claim 1, wherein the optimizer is to track optimizations executed on a specific trace.

9. The processor of claim 1, wherein the optimizer is to pack the trace after optimization.

10. The processor of claim 9, wherein the optimizer is to pack the trace by optimizing two consecutive lines of a trace simultaneously.

11. The processor of claim 10, wherein the optimizer is to use an alternating offset to determine the two consecutive lines of the trace to optimize together.

12. The processor of claim 1, wherein optimizations includes at least one of a group of optimizations consisting of call return elimination, dead code elimination, dynamic Lop fusion, binding, load balancing, move elimination, common sub-expression elimination, constant propagation, redundant load elimination, store forwarding, memory renaming, trace specialization, value specialization, reassociation, and branch promotion.

13. The processor of claim 1, wherein the optimizer executes optimizations based on runtime information collected during execution of the trace.

14. The processor of claim 13, wherein the runtime information is appended to the trace in the trace cache.

15. The processor of claim 13, further comprising a runtime information buffer to store the runtime information, the runtime information buffer mapped to the trace cache to match the runtime information with the trace.

16. An optimization unit comprising:
an input to receive a trace each time the trace is sent to a processing core; and
an optimizer to optimize the trace.

17. The optimizing unit of claim 16, wherein the optimizer is a pipelined optimizer.

18. The optimizing unit of claim 16, further comprising an output connected to a trace cache to store an optimized trace after optimization by the optimizer.

19. The optimizing unit of claim 16, wherein the input is connected to an allocator, the allocator to send traces from a trace queue storing optimized and unoptimized traces to the processing core and the optimizer.

20. The optimizing unit of claim 16, wherein the optimizer tracks optimizations executed on a specific trace.

21. The optimizing unit of claim 16, wherein the optimizer packs the trace after optimization.

22. The optimizing unit of claim 21, wherein the optimizer packs the trace by optimizing two or more consecutive lines of a trace simultaneously.

23. The optimizing unit of claim 22, wherein the optimizer uses an alternating offset to determine the two or more consecutive lines of the trace to optimize.

24. The optimizing unit of claim 16, wherein optimizations includes at least one of a group of optimizations consisting of call return elimination, dead code elimination, dynamic μop fusion, binding, load balancing, move elimination, common sub-expression elimination, constant propagation, redundant load elimination, store forwarding, memory renaming, trace specialization, value specialization, reassociation, and branch promotion.

25. The optimizing unit of claim 16, wherein the optimizer executes optimizations based on runtime information collected during execution of the trace.

26. A method comprising:
executing a trace in a processing core; and
simultaneously optimizing the trace each time the trace is executed.

27. The method of claim 26, further including storing the trace after optimization in a trace cache.

28. The method of claim 27, further including storing unoptimized traces to be processed and optimized.

29. The method of claim 28, further comprising:
storing static code from a compiler;
translating the static code into micro-operations; and
building an unoptimized trace from the micro-operations.

30. The method of claim 26, wherein the processing core is an out of order processing core.

31. The method of claim 26, further including tracking optimizations executed on a specific trace.

32. The method of claim 26, further including packing the trace after optimization.

33. The method of claim 32, wherein the trace is packed by optimizing two or more consecutive lines of a trace simultaneously.

34. The method of claim 33, further including using an alternating offset to determine the two or more consecutive lines of the trace to optimize.

35. The method of claim 26, wherein optimizing includes at least one of a group of optimizations consisting of call return elimination, dead code elimination, dynamic pop fusion, binding, load balancing, move elimination, common sub-expression elimination, constant propagation, redundant load elimination, store forwarding, memory renaming, trace specialization, value specialization, reassociation, and branch promotion.

36. The method of claim 26, further including optimizing based on runtime information collected during execution of the trace.

37. The method of claim 36, further including appending the runtime information to the trace.

38. A system comprising:
a memory to store a trace;
a processor coupled to said memory to execute a trace in a processing core and to simultaneously optimize the trace each time the trace is executed.

39. The system of claim 38, wherein the processor has an out of order processing core.

40. The system of claim 38, wherein the processor tracks optimizations executed on a specific trace.

41. The system of claim 38, wherein the processor packs the trace after optimization.

42. The system of claim 41, wherein the trace is packed by optimizing two or more consecutive lines of a trace simultaneously.

43. The system of claim 42, wherein an alternating offset is used to determine the two or more consecutive lines of the trace to optimize.

44. The system of claim 38, wherein optimizing includes at least one of a group of optimizations consisting of call return elimination, dead code elimination, dynamic pop fusion, binding, load balancing, move elimination, common sub-expression elimination, constant propagation, redundant load elimination, store forwarding, memory renaming, trace specialization, value specialization, reassociation, and branch promotion.

45. The system of claim 38, wherein the trace is optimized based on runtime information collected during execution.

46. A set of instructions residing in a storage medium, said set of instructions capable of being executed by a processor to implement a method for processing data, the method comprising:
executing a trace in a processing core; and
simultaneously optimizing the trace each time the trace is executed.

47. The set of instructions of claim 46, further including tracking optimizations executed on a specific trace.

48. The set of instructions of claim 46, further including packing the trace after optimization.

49. The set of instructions of claim 48, wherein the trace is packed by optimizing two or more consecutive lines of a trace simultaneously.

50. The set of instructions of claim 49, further including using an alternating offset to determine the two or more consecutive lines of the trace to optimize.

51. The set of instructions of claim 46, wherein optimizing includes at least one of a group of optimizations consisting of call return elimination, dead code elimination, dynamic μop fusion, binding, load balancing, move elimination, common sub-expression elimination, constant propagation, redundant load elimination, store forwarding, memory renaming, trace specialization, value specialization, reassociation, and branch promotion.

52. The set of instructions of claim 46, further including optimizing based on runtime information collected during execution of the trace.

53. The set of instructions of claim 52, further including appending the runtime information to the trace.
